(19) United States
(12) Patent Application Publication
(10) Pub. No.: US 2008/0280065 A1
(43) Pub. Date: Nov. 13, 2008

(54) Method and Device for Generating a Low-Pressure Plasma and Applications of the Low-Pressure Plasma

(76) Inventors: Peter Fornsel, Spenge (DE); Christian Buske, Steinhagen (DE); Uwe Hartmann, Horn-Bad-Meinberg (DE)

Correspondence Address: PROSKAUER ROSE LLP;PATENT DEPARTMENT, 1585 BROADWAY, NEW YORK, NY, 10036-8299, US

(21) Appl. No.: 11/547,854

(22) PCT Filed: Apr. 1, 2005
(86) PCT No.: PCT/EP2005/003442

§ 371 Date: Jan. 10, 2008

(30) Foreign Application Priority Data
Apr. 9, 2004 (DE) 10 2004 017 923.9

(51) Int. Cl. B01J 19/08; H05H 1/24

(52) U.S. Cl. 427/569; 118/50; 204/164

(57) ABSTRACT

The present invention relates to a method for generating a low-pressure plasma, in which a partial vacuum is generated by means of a vacuum pump in a low-pressure chamber, and a plasma jet is introduced at higher pressure into the low-pressure chamber. The present invention also relates to various applications of the low-pressure plasma for surface pretreatment, for surface coating, or for treating gases. The present invention also relates to a device for generating a low-pressure plasma.

### BACKGROUND

The present invention relates to a method and a device for generating a low-pressure plasma as well as various applications of this method and this device.

Methods and devices for generating a low-pressure plasma are known from the prior art. These are essentially based on generating a partial vacuum in a low-pressure chamber. An operating gas is introduced in a targeted way into the low-pressure chamber, in which a gas discharge is ignited between two electrodes. The operating gas contained in the low-pressure chamber, which may also be a gas mixture in general, is then excited by the discharge to form a plasma. The generated plasma is distributed within the low-pressure chamber because of thermal effects. As an alternative to the gas discharge, the plasma excitation may also be performed by a microwave field.

Low-pressure plasmas of this type have the disadvantage that their intensity is limited because of the low density of the operating gas. This is because a partial vacuum is required to generate the low-pressure plasma in order to be able to ignite and maintain a plasma discharge at all. However, the higher the pressure is set in the low-pressure chamber, the lower is the intensity of the plasma.

For these reasons, the known methods for processing workpieces using a low-pressure plasma, for example, for treating a workpiece, have long processing times, which represent a limiting factor for the effectiveness of the overall processing of the workpieces.

### SUMMARY OF THE INVENTION

The present invention is thus based on the technical problem of improving the effectiveness of the known methods and devices for generating a low-pressure plasma and for applying a low-pressure plasma.

The technical problem described above is solved according to a first teaching of the present invention by a method for generating a low-pressure plasma having the features of Claim 1. The method comprises the two method steps of generating a partial vacuum by means of a vacuum pump and a low-pressure chamber and introducing a plasma jet at higher pressure into the low-pressure chamber.

During the introduction of the plasma jet, which has a higher gas pressure than the low-pressure chamber, the operation of the vacuum pump is maintained, so that an equilibrium results between the introduced plasma gas together with the remaining part of the non-excited operating gas and the gas pumped out. The gas pressure of the plasma jet may be up to more than atmospheric pressure. A plasma thus propagates at high intensity within the low-pressure chamber. Correspondingly high pumping levels must be ensured by the vacuum pump, so that the low pressure may be maintained in spite of the gas flow out of the plasma nozzle.

The advantage of the present invention is that an operating gas is excited to form a plasma at higher pressures, up to more than atmospheric pressure, and thus a significantly more intensive plasma jet is formed than is the case for the discharge or microwave excitation occurring in the low-pressure chamber under partial vacuum.

This is because, since the plasma jet is generated in a plasma source outside the low-pressure chamber, the higher operating gas pressures may be set therein, without the pressure of the low-pressure chamber being increased too strongly.

It has been shown in experiments that at different partial vacuums in the low-pressure chamber, the shape of the exiting plasma jet changes. If the plasma jet comes out of the nozzle opening in the shape of a focused flame, comparable to the shape of a candle flame, at atmospheric pressure, the plasma jet expands ever further as the partial vacuums become lower, until the plasma jet already dissolves shortly after coming out of the nozzle opening from a specific partial vacuum and the plasma is distributed within the low-pressure chamber.

The partial vacuum range is specified from 10 mbar to 300 mbar for this purpose as an example, within which the changes of the plasma jet described above result. This range has been found by experiment, but is not to be understood as restrictive for the present invention. The particular pressure conditions and geometries within the low-pressure chamber and the pressure of the operating gas used in the plasma source significantly influence the shaping of the plasma jet and/or the plasma within the low-pressure chamber.

A further advantage of the present invention is that because of the low pressure in the low-pressure chamber, the plasma has a longer residence time than is the case in plasma generation under atmospheric pressure. The plasma may thus be used for a longer time than has been the case in the application of the plasma sources known up to this point.

The plasma source may generate the plasma jet in different ways.

A plasma nozzle system, which is known from the prior state of the art of EP 0 761 415 A1 or EP 1 335 641 A1, is preferably used. In this plasma source, a plasma jet which exits from the nozzle opening is generated from the operating gas using a non-thermal discharge by applying a high-frequency high voltage in a nozzle tube between a pin electrode and an electrode in the area of the nozzle opening. This non-thermal plasma jet has no electrical sparks at a suitably set flow rate, so that only the high-energy, but low-temperature plasma jet leaves the nozzle opening. One also refers to a high electron temperature and a low ion temperature to characterize the plasma jet.

In the prior art of DE 37 33 492, the plasma jet is generated using a corona discharge by ionizing an operating gas, such as air. The device comprises a ceramic tube which is enclosed at the outer wall by an external electrode. An internal electrode is situated as a rod at a few millimeters distance to the inner wall of the ceramic tube. An ionizable gas such as air or oxygen is conducted through the gap between the inner wall of the ceramic tube and the internal electrode. A high-frequency high voltage field is applied to the two electrodes, as is used in a corona pretreatment of films. The gas conducted through is ionized by the AC field and comes out at the end of the tube.

Generating a plasma jet by applying a high-frequency voltage field, for example, a microwave field, in an operating gas is also known. This type of excitation does not require the generation of a gas discharge and is thus less efficient than the plasma source described first.

In the end, however, the type of excitation of the operating gas for the plasma generation is not decisive.

According to a second teaching of the present invention, the technical problem described above is solved by a method for surface pretreatment of a workpiece in a low-pressure plasma, in which a workpiece is situated in a chamber, a partial vacuum is generated by means of a vacuum pump in a low-pressure chamber, a plasma jet having higher pressure is introduced into the low-pressure chamber, and the surface of the workpiece is pretreated by the plasma propagating in the low-pressure chamber.

This method uses the method explained above to generate an intensive low-pressure plasma in the low-pressure chamber. The workpiece is situated in this low-pressure chamber filled with the plasma and the surface of the workpiece is pretreated.

Here pretreatment means that the surface is cleaned of contaminants and/or surface layers are removed and/or the surface is activated.

Cleaning the surface of contaminants is based on a plasma having higher energy being generated by means of an aggressive operating gas, such as oxygen, argon, nitrogen, pentane, or mixtures thereof, which results in combustion or reaction of the contaminants. Therefore, organic contaminants in particular, such as fats and oils, may be detached and removed from the surface of the workpiece. This method is preferably applied to metallic workpieces or workpieces made of ceramic materials. The method may also be applied to plastics.

The coating removal of the surface is based on coupling the energy of the plasma into the surface coating, thus resulting in melting and vaporization of the coating material. The coating material which is thus detached, and at least partially enters the gas phase, may then be removed via the vacuum pump.

The activation of the surface is used such that the surface has better wettability for liquids after the pretreatment. The surface of the workpiece per se remains essentially unchanged. By all means, the attempt is made to avoid physical or chemical surface changes.

According to a third teaching of the present invention, the technical problem described above is solved by a method for plasma coating workpieces in a low-pressure plasma, in which a workpiece is situated in a chamber, a partial vacuum is generated in a low-pressure chamber by means of a vacuum pump, a plasma jet is introduced at higher pressure into the low-pressure chamber, a precursor material is supplied, the precursor material reacts in the plasma propagating in the low-pressure chamber, and the workpiece is at least partially coated using the reaction products resulting in the plasma from the precursor material.

Therefore, the intensive plasma jet, which propagates more or less strongly depending on the pressure conditions, may also advantageously be used for plasma coating.

The precursor material, which may be provided in a gaseous, liquid, or solid state, may be supplied either directly into the low-pressure chamber or within the plasma source for this purpose. Within the plasma source, the precursor material may be supplied either to the operating gas or to the plasma jet in the area of the nozzle opening.

The method and the device which are known from EP 1 230 414 are preferably used to generate the plasma jet employing a precursor. For this purpose, the precursor material is supplied to the plasma jet in the area of the nozzle opening, after the plasma gas has left the area of the discharge within the nozzle tube. The precursor material then reacts in the plasma jet coming out of the nozzle opening and the resulting reaction products are deposited from the gas phase upon incidence on the surface of the workpiece.

The change of the shape of the plasma jet at different pressures inside the low-pressure chamber explained above may advantageously be used for the purpose of achieving planar processing, i.e., the pretreatment or the coating, above all on the side of the workpiece facing toward the plasma source. The expanded plasma jet then is incident above all on this surface, whereas the surfaces of the workpiece facing away from the plasma source are shielded. For this purpose, the pressure inside the low-pressure chamber is set such that the plasma jet does not dissolve completely, but expands so strongly that a plasma jet having a larger cross-section than that of the nozzle opening results. The cross-section of the plasma jet may thus be set very precisely by the pressure inside the low-pressure chamber.

In a further embodiment of the method, the workpiece may also be moved in relation to the low-pressure chamber or the plasma jet, through which different sides of the workpiece may be subjected to the expanded plasma jet.

According to a fourth teaching of the present invention, the technical problem described above is solved by a method for treating a gas, in which a partial vacuum is generated by means of a vacuum pump in a low-pressure chamber, a plasma jet is introduced at higher pressure into the low-pressure chamber, and the gas to be treated is supplied.

In general, the term “gas” is understood to mean any gas or gas mixture.

Chemical processes, which require a supply of energy and the occurrence of which may be controlled in particular by the parameters of size and shape of the low-pressure chamber, dimension of the pressure in the low-pressure chamber, and dimension of the gas pressure of the operating gas in the plasma source, may be performed in the gas phase inside the low-pressure chamber nearly arbitrarily by the method according to the present invention. The gases are chemically modified or fragmented under the influence of the plasma, for example.

The gas to be treated may be introduced as an operating gas for generating the plasma jet inside the excitation area of the plasma source. The gas may also be supplied to the plasma jet in the area of the outlet opening of the plasma source. Furthermore, the gas may also be introduced into the low-pressure chamber separately from the plasma source, and then mix with the plasma inside the low-pressure chamber.

In each of the cases described above, the excitation energy of the plasma is used to cause a reaction of the gas. The reaction products and possibly remaining residues of the input gas are then sucked out of the low-pressure chamber and processed further if necessary.

The advantage of this method is the possibility of being able to control the residence time and thus the duration of the treatment of the gas inside the low-pressure chamber through the operating parameters.

The method described above may be used in particular for purification of exhaust gas. For this purpose, it is preferable to use the exhaust gas as the operating gas. Thus, even larger quantities of exhaust gas may be subjected continuously to the chemical reactions in the low-pressure chamber.

All methods of the type described above according to the first four teachings of the present invention may also be performed in combination with the application of a typical low-pressure plasma device. This means that the introduction of the plasma jet using a plasma nozzle is supported and supplemented by generating a low-pressure plasma inside the volume of the low-pressure chamber. All methods for generating a low-pressure plasma known for this purpose and described above may be used for this purpose.

A special advantage of the application of both types of plasma generation is, inter alia, that areas having different plasma concentrations may be generated in a targeted way inside the low-pressure chamber. Thus, for example, a slight but uniformly distributed concentration of the plasma resulting from the low-pressure plasma generation may be superimposed on a concentrated plasma distribution in a specific area, for example, in the center of the low-pressure chamber.

It is also possible to use one of the plasmas for surface pretreatment and the other plasma for plasma coating. Different plasma gases may also be used, for example, the plasma of the plasma nozzle may be generated using air, whereas the low-pressure plasma is generated using a gas mixture containing argon.

In addition, different plasmas, both of which are introduced into the low-pressure chamber, may be generated using two independent plasma nozzles. Different operating gases may also be used for this purpose in order to be able to achieve different effects.

According to a fifth teaching of the present invention, the technical problem described above is solved by a device for generating a low-pressure plasma which has a low-pressure chamber, a vacuum pump connected to the low-pressure chamber, and at least one plasma source, which is connected to the low-pressure chamber, for generating a plasma jet.

This device is explained in greater detail in the following on the basis of exemplary embodiments with reference to the attached drawing. In the drawing:

### BRIEF DESCRIPTION OF THE DRAWINGS

FIG. 1 shows a first exemplary embodiment of a device according to the present invention for generating a low-pressure plasma in a schematic illustration,

FIG. 2 shows a second exemplary embodiment of a device according to the present invention for generating a low-pressure plasma in a schematic illustration, and

FIG. 3 shows a third exemplary embodiment of a device according to the present invention for generating a low-pressure plasma in a schematic illustration.

### DETAILED DESCRIPTION OF THE DRAWINGS

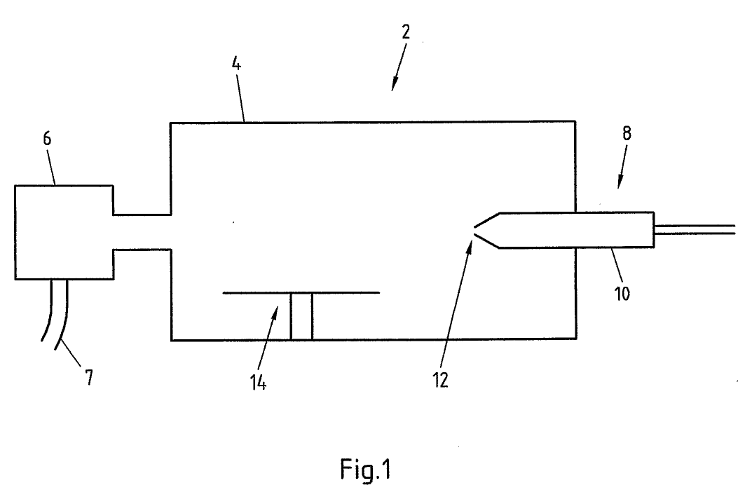

FIG. 1 schematically shows a first exemplary embodiment of a device according to the present invention for generating a low-pressure plasma in a low-pressure chamber 2, to whose chamber wall 4 a vacuum pump 6 is attached, which is connected to the interior of the low-pressure chamber 2. In operation, the vacuum pump 6 evacuates the low-pressure chamber 2 and may also maintain a settable partial vacuum if a gas flow is supplied constantly. The vacuum pump 6 has a gas outlet which is connected to an exhaust gas line 7.

Furthermore, the low-pressure chamber 2 is connected to a plasma source 8 for generating a plasma jet. The plasma source 8 may also be referred to as a plasma nozzle, since the plasma jet generated inside the nozzle tube 10 exits through a nozzle opening 12 and represents a jet accelerated by the nozzle action and by the plasma pressure inside the plasma zone. The plasma source 8 has supply lines for the operating gas and for an activator.

As FIG. 1 also shows, the plasma jet is directed inside the low-pressure chamber 2 in the direction of the connection point of the vacuum pump 6.

Furthermore, a holder for a workpiece to be processed (not shown) is situated inside the low-pressure chamber 2. In the exemplary embodiment shown in FIG. 1, the holder is implemented as a table 14, on which the workpiece may be laid.

For uniform distribution of the plasma on the workpiece, relative movements between workpiece and plasma source may be used, e.g., by rotation of the workpiece in relation to the plasma source.

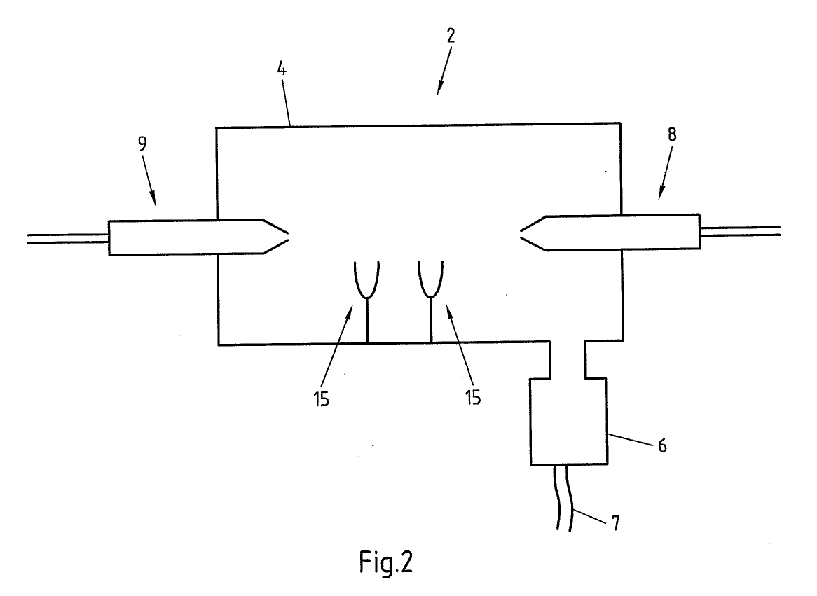

FIG. 2 shows a further exemplary embodiment of the present invention. This exemplary embodiment differs from the exemplary embodiment shown in FIG. 1 in that two plasma sources 8 and 9 are provided, which are situated in side walls of the low-pressure chamber 2 diametrically opposite of one another. Both plasma jets are thus oriented toward one another, through which the turbulence of the plasma jets is increased.

In this embodiment the vacuum pump 6 is situated on the floor of the low-pressure chamber 2.

As shown in FIG. 2, the holder is implemented in the form of two holding rings 15 open on top, so that a workpiece laid thereon only has a small contact surface and largely freely accessible surfaces.

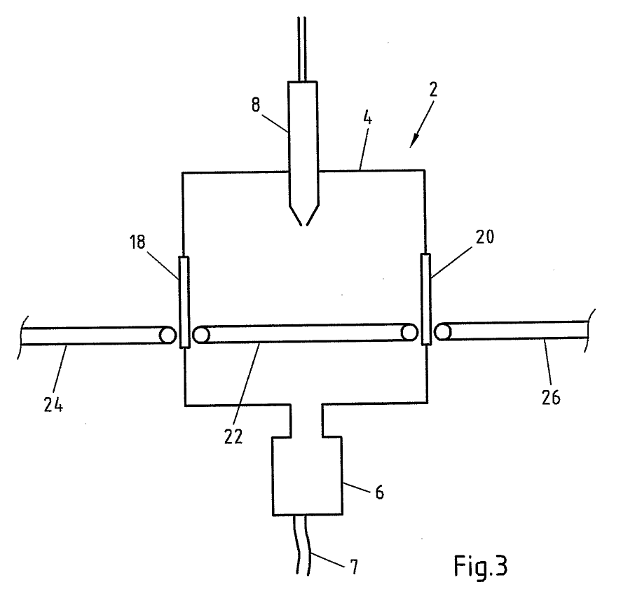

FIG. 3 shows a third exemplary embodiment, in which the low-pressure chamber 2 is implemented as a tunnel, which may be situated in a production line. For this purpose, the low-pressure chamber 2 has lock openings 18 and 20 for introducing and removing workpieces. The holder is implemented as a conveyor belt 22, which adjoins the two lock openings 18 and 20 in the interior of the low-pressure chamber 2. To introduce and remove workpieces, the lock openings 18 and 20 are opened, so that it is possible to transport workpieces in and out via further conveyor belts 24 and 26.

1. A method for generating a low-pressure plasma,
wherein a partial vacuum is generated in a low-pressure chamber by means of a vacuum pump, and
a plasma jet is introduced at higher pressure into the low-pressure chamber.

2. The method according to claim 1,
wherein more than one plasma jet is introduced into the low-pressure chamber.

3. The method according to claim 1,
wherein an additional plasma is generated in the low-pressure chamber using a low-pressure plasma source.

4. A method for surface pretreatment of a workpiece in a low-pressure plasma,
wherein a workpiece is situated in a low-pressure chamber,
a low-pressure plasma is generated in the low-pressure chamber by means of the method according to claim 1, and
the surface of the workpiece is pretreated by the plasma propagating in the low-pressure chamber.

5. A method for plasma coating of a workpiece in a low-pressure plasma,
wherein a workpiece is situated in a low-pressure chamber,
a low-pressure plasma is generated in the low-pressure chamber by means of a method according to claim 1,
precursor material is supplied,
the precursor material reacts in the plasma propagating in the low-pressure chamber, and
the workpiece is at least partially coated using the reaction products resulting in the plasma from the precursor material.

6. The method according to claim 5,
wherein the gaseous, liquid, or solid precursor material is supplied to the plasma inside the plasma source or in the low-pressure chamber.

7. A method for treating a gas,
wherein a low-pressure plasma is generated in a low-pressure chamber by means of a method according to claim 1 and
the gas to be treated is supplied to the low-pressure chamber.

8. A device for generating a low-pressure plasma,
having a low-pressure chamber (2),
having a vacuum pump (6) connected to the low-pressure chamber (2), and
having at least one plasma source (8), which is connected to the low-pressure chamber (2), for generating an atmospheric plasma jet.

9. A device according to claim 8,
wherein
locks (18, 20) are provided in the low-pressure chamber (2) for entry and exit of workpieces.
